(19) United States
(12) Patent Application Publication
(10) Pub. No.: US 2014/0066210 A1
(43) Pub. Date: Mar. 6, 2014

(54) SERVER DEVICE, AND NON-TRANSITORY COMPUTER-READABLE STORAGE MEDIUM STORING GAME PROGRAM

(71) Applicant: DeNA Co., Ltd., Tokyo (JP)

(72) Inventor: Yoshiki WATABE, Tokyo (JP)

(73) Assignee: DeNA Co., Ltd., Tokyo (JP)

(21) Appl. No.: 13/970,884

(22) Filed: Aug. 20, 2013

(30) Foreign Application Priority Data
Aug. 30, 2012 (JP) 2012-190374

(51) Int. Cl. A63F 13/12

(52) U.S. Cl. CPC A63F 13/12
USPC 463/42

(57) ABSTRACT

A server device includes a storage unit; an acceptance processing unit that accepts requests from a player through a player terminal to use a predetermined item and to capture an enemy character; a parameter change processing unit that changes the parameter of the enemy character stored in the storage unit, when the request to use the predetermined item is accepted; a capture determining unit that determines, when the request to capture the enemy character is accepted, whether capture of the enemy character has succeeded, according to the parameter of the enemy character changed by the parameter change processing unit; and a capture processing unit that allows the storage unit to store information when it is determined that the capture of the enemy character has succeeded, the information indicating that the enemy character has been captured by the player.

### CROSS-REFERENCE TO RELATED APPLICATIONS

This application claims the benefit of Japanese Patent Application No. 2012-190374, filed Aug. 30, 2012, the disclosure of which is hereby incorporated by reference in its entirety.

### BACKGROUND OF THE INVENTION

1. Field of the Invention

The present invention relates to a server device, and a non-transitory computer-readable storage medium storing a game program.

2. Description of Related Art

Conventionally, games in which a player does combat (battle) with enemy characters are widely known. Of such games, there is a game in which, when a player gives damage of a certain level or more to an enemy character, the player can capture the enemy character (see, for example, “Pocket Monsters: Red/Green/Blue Winning Strategy”, Futabasha Publishers, Ltd., published in Oct. 15, 1997).

### SUMMARY OF THE INVENTION

In a game in which enemy characters can be captured, in many cases, a determination as to whether capture has succeeded is commonly made based on a predetermined success rate. For example, by setting a high probability of being able to capture an enemy character by weakening the enemy character by giving damage of a certain degree to the enemy character, the player's zest for capturing is increased.

However, there are many cases in which a player gives too much damage to an enemy character upon a battle and accordingly wins the battle with the enemy character, resulting in the player not being able to capture the enemy character, and in which the probability that a player encounters an enemy character to be captured is low and thus it is difficult for the player to capture the enemy character. In such cases, a player cannot capture an enemy character unless he/she continues a game for an extended period of time to do battle again and again. Thus, the convenience for capturing an enemy character is low.

The present invention is made in view of such circumstances, and an object of the present invention is to provide a method with high convenience for capturing an enemy character in a game in which enemy characters can be captured.

The main aspect of the present invention to solve the above-described problem is directed to a server device connected to a player terminal through a network and controlling a game in which, when a player does battle with an enemy character, the player can capture the enemy character, the server device including: a storage unit that stores information about a parameter of the enemy character and about the enemy character captured by the player during the game; an acceptance processing unit that accepts requests from the player through the player terminal to use a predetermined item and to capture the enemy character; a parameter change processing unit that changes the parameter of the enemy character stored in the storage unit, when the request to use the predetermined item is accepted; a capture determining unit that determines, when the request to capture the enemy character is accepted, whether capture of the enemy character has succeeded, according to the parameter of the enemy character changed by the parameter change processing unit; and a capture processing unit that allows the storage unit to store information when it is determined that the capture of the enemy character has succeeded, the information indicating that the enemy character has been captured by the player.

Other features of the present invention will become apparent from the description of the present specification and the accompanying drawings.

According to the present invention, a method with high convenience for capturing an enemy character in a game in which enemy characters can be captured can be provided.

### BRIEF DESCRIPTION OF THE DRAWINGS

FIG. 1 is a diagram showing an example of an overall configuration of a game system 1 according to the present embodiment;

FIG. 2 is a block diagram showing a functional configuration of a server device 10 according to the present embodiment;

FIG. 3 is a block diagram showing a functional configuration of a player terminal 20 according to the present embodiment;

FIGS. 4A to 4C are diagrams showing examples of a battle screen displayed upon capturing;

FIGS. 5A and 5B are diagrams showing examples of a battle screen displayed when a capture assisting item is used;

FIG. 6 is a diagram describing the flow of a process performed when a capture assisting item is used upon a battle;

FIGS. 7A and 7B are diagrams showing examples of a table for determining the capture success rate; and

FIG. 8 is a diagram showing an example of data managed as capture information.

### DETAILED DESCRIPTION OF THE INVENTION

At least the following matters will become apparent from the description of the present specification and the accompanying drawings.

A server device connected to a player terminal through a network and controlling a game in which when a player does battle with an enemy character, the player can capture the enemy character is characterized by including: a storage unit that stores information about a parameter of the enemy character and about the enemy character captured by the player during the game; an acceptance processing unit that accepts requests from the player through the player terminal to use a predetermined item and to capture the enemy character; a parameter change processing unit that changes the parameter of the enemy character stored in the storage unit, when the request to use the predetermined item is accepted; a capture determining unit that determines, when the request to capture the enemy character is accepted, whether capture of the enemy character has succeeded, according to the parameter of the enemy character changed by the parameter change processing unit; and a capture processing unit that allows the storage unit to store information when it is determined that the capture of the enemy character has succeeded, the information indicating that the enemy character has been captured by the player.

According to such server device, a method with high convenience for capturing an enemy character in a game in which enemy characters can be captured can be provided.

In addition, in the server device, when the request to use the predetermined item is accepted by the player, the parameter change processing unit may reduce the parameter of the enemy character such that the parameter does not fall below a set lower limit.

According to such server device, by increasing the capture success rate by suppressing giving too much damage to an enemy character to be captured in a battle, the player's convenience can be further increased.

In addition, in the server device, the storage unit may store a parameter of a character of the player, and when the request to use the predetermined item is accepted by the player, the parameter change processing unit may not change the parameter of the character of the player stored in the storage unit.

According to such server device, in capture operation during a battle, a player can safely capture an enemy character without receiving damage from the enemy character.

In addition, the server device may include a capture success rate determining unit that determines a capture success rate used upon capturing the enemy character, according to the parameter of the enemy character changed by the parameter change processing unit, and the capture success rate determining unit may set a higher capture success rate of the enemy character when the predetermined item is used than when the predetermined item is not used.

According to such server device, by using a capture assisting item, an increase in capture success rate is exhibited more remarkably. Thus, a player is likely to be motivated to use the capture assisting item.

Disclosed is a non-transitory computer-readable storage medium storing a game program that causes an information processing device to perform a game in which, when a player does battle with an enemy character, the player can capture the enemy character, and that causes the information processing device to perform: a process of storing, in a storage unit, information about a parameter of the enemy character and about the enemy character captured by the player during the game; a process of accepting requests from the player to use a predetermined item and to capture the enemy character; a process of changing the parameter of the enemy character stored in the storage unit, when the request to use the predetermined item is accepted; a process of determining, when the request to use the predetermined item is accepted, whether capture of the enemy character has succeeded, according to the parameter of the enemy character changed by a parameter change processing unit; and a process of allowing the storage unit to store information when it is determined that the capture of the enemy character has succeeded, the information indicating that the enemy character has been captured by the player.

### Embodiment

<For The Configuration Of A Game System>

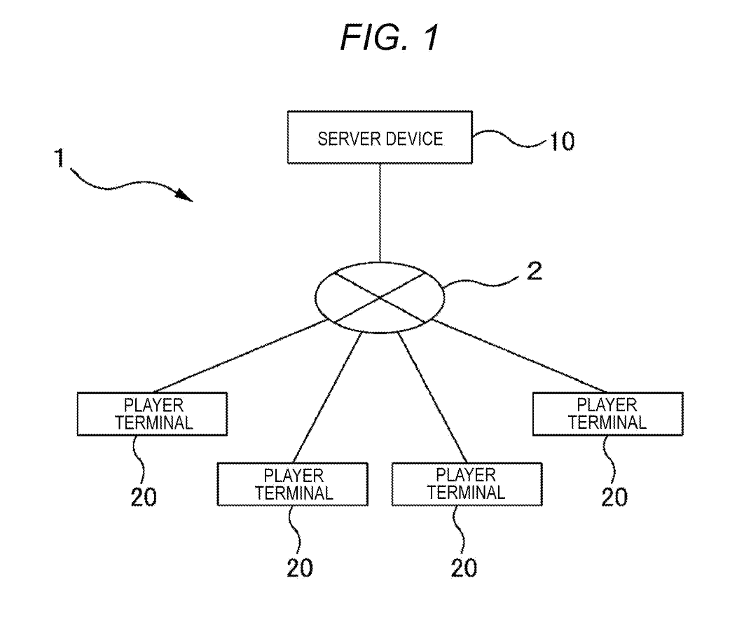

FIG. 1 is a diagram showing an example of an overall configuration of a game system 1 according to the present embodiment.

The game system 1 provides users (hereinafter, also called “players”) with various types of services regarding games (social games) through a network 2. The game system 1 is configured to include a server device 10 and a plurality of player terminals 20 which are connected to the network 2 in a communicable manner.

A player can play a game transmitted through the network 2, by accessing the game system 1 from a player terminal 20. In addition, the player can communicate with a plurality of other players by accessing the game system 1.

<Server Device 10>

The server device 10 is an information processing device which is used when a system administrator, etc., operate and manage game services.

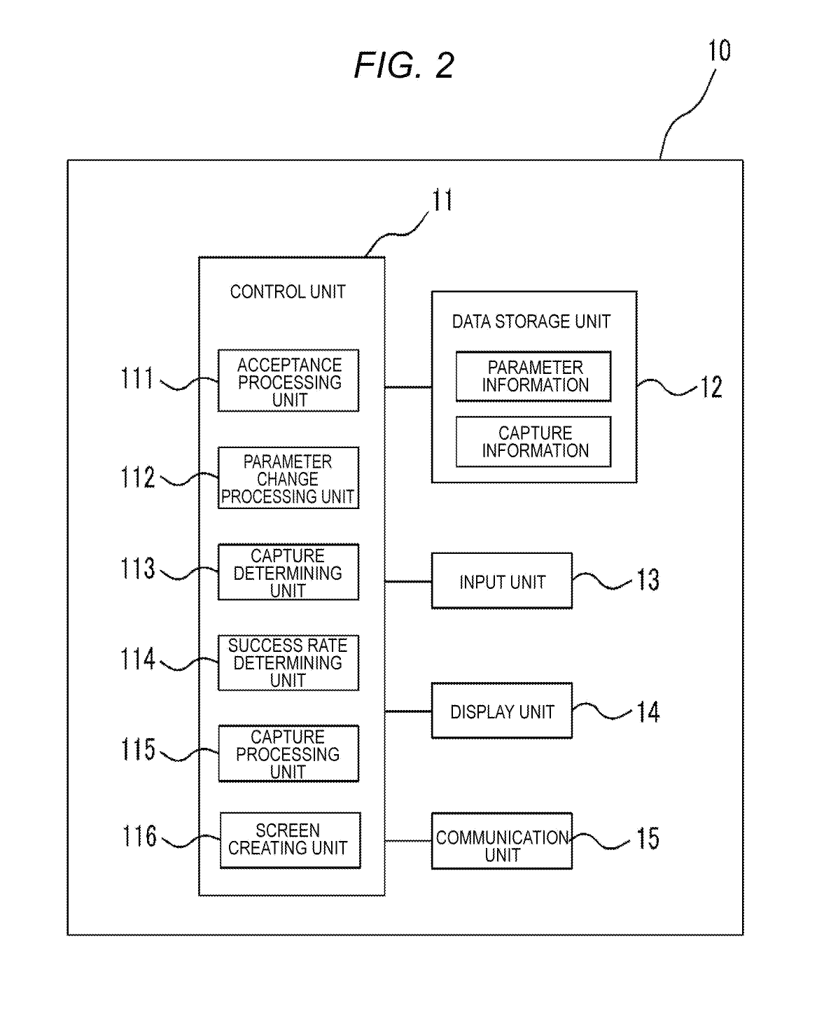

FIG. 2 is a block diagram showing a functional configuration of the server device 10. The server device 10 of the present embodiment has a control unit 11, a data storage unit 12, an input unit 13, a display unit 14, and a communication unit 15.

The control unit 11 passes data between the units and performs overall control of the server device 10. The control unit 11 has an acceptance processing unit 111, a parameter change processing unit 112, a capture determining unit 113, a success rate determining unit 114, a capture processing unit 115, and a screen creating unit 116. Specific operation of each unit will be described later.

The data storage unit 12 stores information about the parameters of enemy characters, information about the parameters of player characters, information on enemy characters captured by players, and the like.

The input unit 13 is for inputting, by the system administrator, etc., various types of data and settings for games (e.g., the setting of a capture success rate which will be described later, etc.). The input unit 13 is implemented by, for example, a keyboard, a mouse, etc.

The display unit 14 is for displaying an operation screen for the system administrator, based on an instruction from the control unit 11. The display unit 14 is implemented by, for example, a liquid crystal display (LCD) or the like.

The communication unit 15 is for performing communication with the player terminals 20. The communication unit 15 has a function serving as a receiving unit that receives various types of data and signals transmitted from the player terminals 20, and a function serving as a transmitting unit that transmits various types of data and signals to the player terminals 20 in response to instructions from the control unit 11. The communication unit 15 is implemented by, for example, a NIC (Network Interface Card) or the like.

<Player Terminals 20>

A player terminal 20 is an information processing terminal operated by a player (user) when playing a game. The player terminal 20 is, for example, a mobile phone terminal, a smartphone, a personal computer, a game machine, or the like, and transmits and receives information to/from the server device 10 accessible through the network 2.

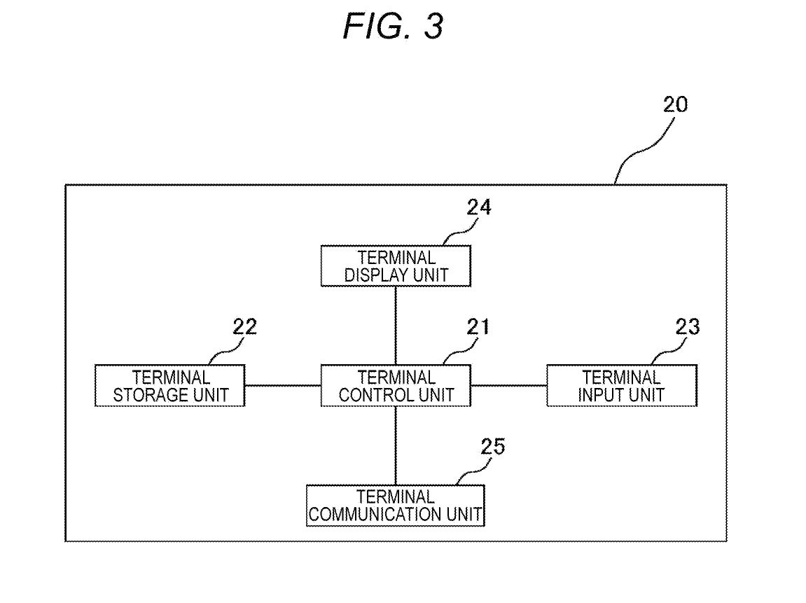

FIG. 3 is a block diagram showing a functional configuration of the player terminal 20. The player terminal 20 of the present embodiment has a terminal control unit 21, a terminal storage unit 22, a terminal input unit 23, a terminal display unit 24, and a terminal communication unit 25.

The terminal control unit 21 passes data between the units and performs overall control of the player terminal 20.

The terminal storage unit 22 is connected via a bus to the terminal control unit 21, and performs the processes of referring to, reading, and rewriting data stored therein, in response to instructions from the terminal control unit 21.

The terminal input unit 23 is for performing various types of operation (game operation, text input operation, etc.) by the player. The terminal input unit 23 is implemented by, for example, operation buttons, a touch panel, etc.

The terminal display unit 24 is for displaying game screens (battle screens which will be described later, etc.) which are created based on game information and in response to instructions from the terminal control unit 21. The terminal display unit 24 is implemented by, for example, a liquid crystal display (LCD) or the like.

The terminal communication unit 25 is for performing communication with the server device 10, and has a function serving as a receiving unit that receives various types of data and signals transmitted from the server device 10, and a function serving as a transmitting unit that transmits various types of data and signals to the server device 10 in response to instructions from the terminal control unit 21. The terminal communication unit 25 is implemented by, for example, a NIC (Network Interface Card) or the like.

### Operation Of A Game

<Summary Of A Game>

A summary of a game provided by the game system 1 will be briefly described.

A game (social game) provided in the present embodiment progresses by a player doing missions and battle.

The “missions” refer to assignments and duties given to the player during the game, and are called in different ways depending on the game, e.g., “quests” and “searches”. A mission is accomplished by performing a plurality of events.

The “events” refer to incidents occurring during the progress of the mission and include, for example, an event where the player gets money (in-game currency), items, etc., usable during the game and an event where the player encounters an enemy character and does battle with the enemy character. In the game of the present embodiment, when the player does battle with an enemy character, the player can capture the enemy character. The player can also allow the successfully captured enemy character to participate in the next and subsequent battles as his/her ally. By this, the player can enjoy high-strategy battles.

The player can allow the game to progress by accomplishing missions one by one which are given one after another.

Information such as experience points, level, owned money, hit points (hereinafter, described as HP), attack power, defense power, and action points is set for each player as parameters. The parameters change according to the progress of the game. For example, when the player performs a certain event, experience points or owned money increases as a result of the event. When the experience points reach a certain value or more, the player's level increases and accordingly attack power, defense power, etc., increase, facilitating the progress of the game.

When the player performs a certain event during a mission, a predetermined amount of action points which is determined according to the event is consumed. If the player's action points fall below the action points required to perform the event, then the player cannot perform the event anymore and thus the mission cannot progress. Note that the action points recover with the passage of time.

<For Capture>

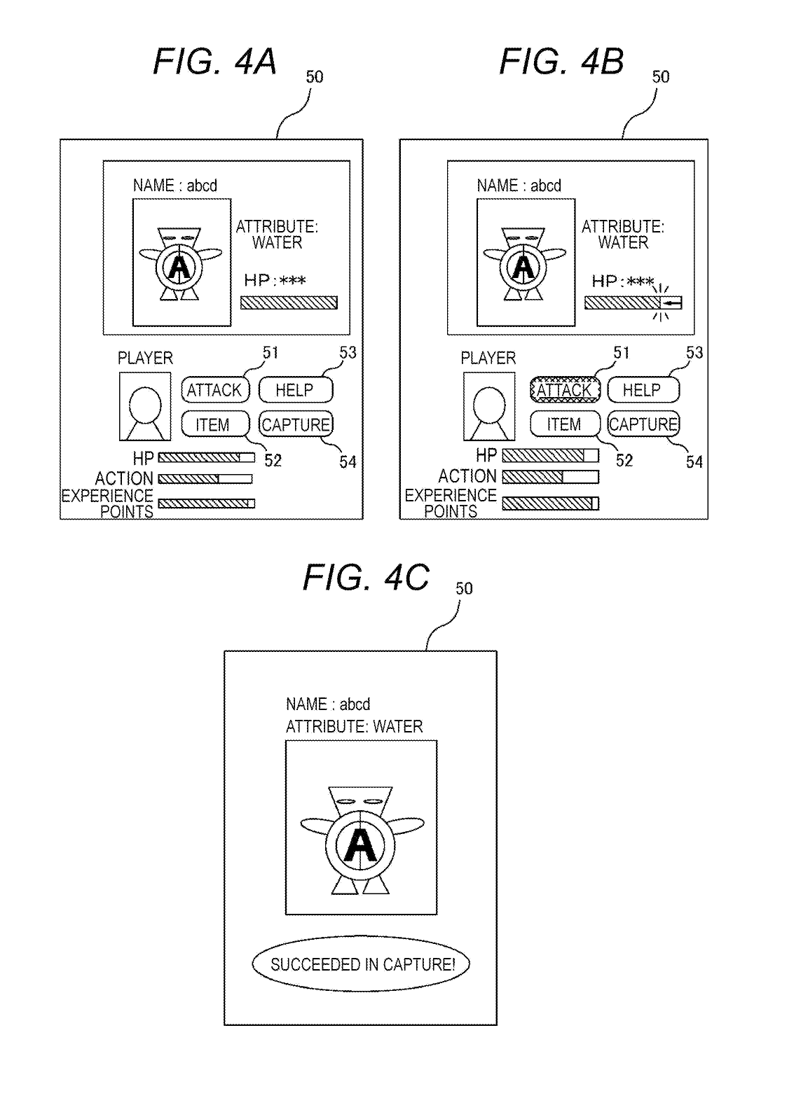

The flow of “capture” operation which is performed upon a battle with an enemy character will be described. FIGS. 4A to 4C are diagrams showing examples of a battle screen displayed upon capturing.

When a battle takes place in a game provided by the game system 1 of the present embodiment, data on a screen (battle screen 50) such as that shown in FIG. 4A is generated by the screen creating unit 116 in the control unit 11, and the battle screen 50 is displayed on the terminal display unit 24 of the player terminal 20. On the battle screen 50 are displayed the graphics of an enemy character and information such as the HP and attribute of the enemy character. Likewise, the graphics of a player character and information such as the HP, action points, and experience points of the player character are displayed. Various types of buttons for instructing player's actions are displayed in the vicinity of the player character. For example, an attack button 51, an item button 52, a help button 53, a capture button 54, etc., are displayed.

When the battle starts, the player inputs various types of instructions by pressing (touching) the buttons displayed on the terminal display unit 24. For example, when the player presses the attack button 51 (inputs an attack instruction), the parameter change processing unit 112 reduces a parameter of the enemy character, such as HP (see FIG. 4B). When the player reduces the HP of the enemy character to zero, it indicates that the player has defeated the enemy character, resulting in the win of the player. On the other hand, when the player receives an attack from the enemy character, the parameter change processing unit 112 reduces the HP or the like of the player. When the HP of the player reaches zero, it indicates the loss of the player.

Note that the player can also request another player or an already captured enemy character for help by pressing the help button 53 during the battle to allow another player or the already captured enemy character to participate in the battle as a friend.

When the player inputs a capture instruction by pressing the capture button 54 at predetermined timing during the battle, the capture determining unit 113 determines whether capture of the enemy character has succeeded. The determination as to whether the capture has succeeded is made based on the parameter information or attribute of the enemy character. For example, the success rate determining unit 114 of the server device 10 determines the capture success rate according to the HP of the enemy character which changes during the battle, and a determination as to whether the capture has succeeded is made based on the determined capture success rate.

If it is determined that the capture has succeeded, a capture success screen such as that shown in FIG. 4C is created by the screen creating unit 116 and displayed on the terminal display unit 24. In addition, if it is determined that the capture has succeeded, the capture processing unit 115 stores in the data storage unit 12 information indicating that the captured enemy character has been captured by the player.

In addition, the player is given a card of the captured enemy character, experience points, in-game currency, etc., as a reward for the success in capturing.

### For A Capture Assisting Item

When, as described above, a determination as to whether capture has succeeded is made according to a parameter of an enemy character, the player needs to change the parameter of the enemy character so as to obtain the highest capture success rate. For example, it is assumed that the capture success rate is set such that the lower the HP of the enemy character the higher the capture success rate. In this case, the player needs to capture the enemy character with the HP of the enemy character sufficiently reduced by giving as much damage as possible to the enemy character in a battle. Meanwhile, if the HP of the enemy character reaches zero by giving too much damage, the enemy character is defeated, resulting in the failure of capture of the enemy character. When the capture fails in the battle, the player just has to wait for another chance to encounter the enemy character. This results in the player spending his/her time to encounter the enemy character, greatly impairing the player's convenience.

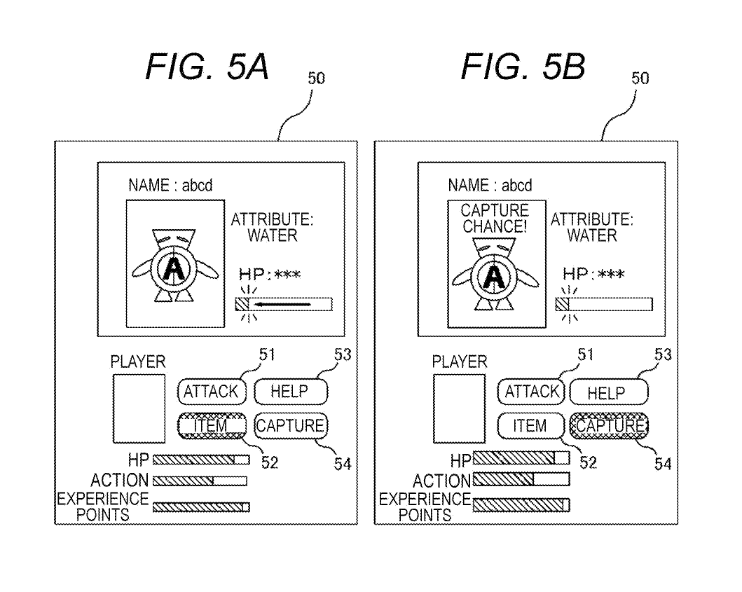

In view of this, in the present embodiment, for efficient success in the “capture” of an enemy character, a predetermined item (hereinafter, called a capture assisting item) is used to increase player's convenience. FIGS. 5A and 5B are diagrams showing examples of a battle screen displayed when a capture assisting item is used.

On a battle screen 50 in FIG. 5A, the player presses an item button 52 displayed on the terminal display unit 24 to select a capture assisting item and input an instruction to use the item. When the capture assisting item is used, the parameter change processing unit 112 reduces a parameter (e.g., HP, etc.) of an enemy character. The amount by which the parameter is reduced may be set in advance or may be changed in each occasion.

When, after verifying that the parameter (HP, etc.) of the enemy character has decreased, the player presses a capture button 54 on the battle screen to input a capture instruction (FIG. 5B), the capture determining unit 113 determines whether the capture has succeeded, based on the parameter of the enemy character changed by using the capture assisting item. Since the parameter is changed (in the above-described example, the HP decreases) so as to obtain a condition where the capture is likely to succeed by using the capture assisting item, the capture success rate of the enemy character significantly increases, resulting in an increase in player's convenience upon capturing the enemy character.

When the capture has succeeded, the same capture success screen as that shown in FIG. 4C is displayed.

<Specific Process Performed When A Capture Assisting Item Is Used>

A specific process for enemy character capture operation in a battle which is performed by the server device 10 will be described.

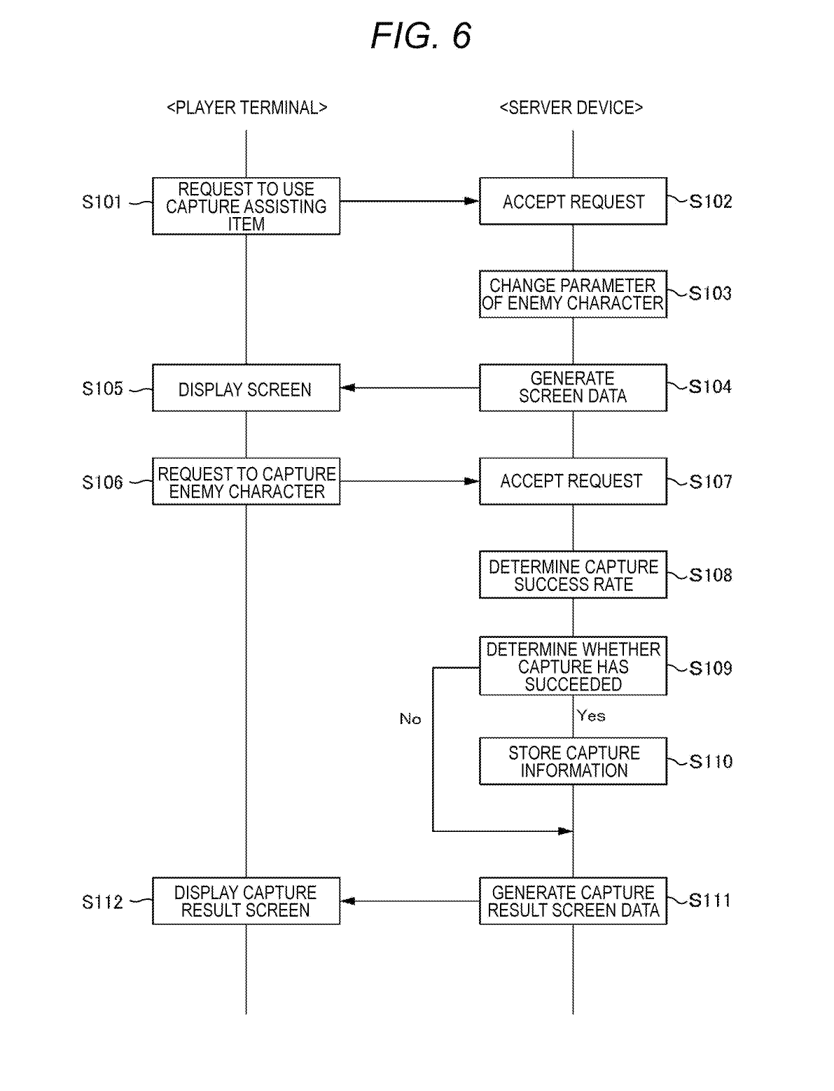

FIG. 6 is a diagram describing the flow of a process performed when a capture assisting item is used upon a battle. Note that for simplification of description it is assumed that a battle has already started during a game.

The player requests to use a capture assisting item through the player terminal 20 at predetermined timing during the battle (S101).

When the acceptance processing unit 111 of the server device 10 accepts the request to use a capture assisting item (S102), the parameter change processing unit 112 reads parameter information (e.g., HP value) of an enemy character which is stored in the data storage unit 12, and changes the parameter (S103). As described above, the parameter change range may be set in advance or the parameter may change randomly. For example, when the capture success rate of the enemy character increases as the HP of the enemy character decreases, the parameter change processing unit 112 reduces the HP of the enemy character to the order of 10% of the maximum value of the HP. In any case, the parameter of the enemy character is changed such that the capture success rate increases by using the capture assisting item.

At that time, the parameter change processing unit 112 reduces the parameter such that the parameter does not fall below a lower limit which is set in advance. For example, the parameter change processing unit 112 reduces the HP such that the HP does not fall below 1% of the maximum HP, or reduces the HP such that at least one or more HP of the enemy character remains. This suppresses the failure of capture caused by the player defeating the enemy character to be captured.

In addition, although the parameter change processing unit 112 changes the parameter of the enemy character due to the use of the capture assisting item, the parameter change processing unit 112 does not change the parameters of a player character. By this, the player can safely capture the enemy character without receiving damage from the enemy character in the capture operation during the battle.

The use of the capture assisting item allows the player to easily and safely capture the enemy character. Thus, the player can save the trouble of reducing the HP of the enemy character by performing a normal attack. In addition, since there is no possibility of reducing the HP of the enemy character too much (reducing the HP to zero), it is unlikely to waste the chance of capture.

After changing the parameter of the enemy character, the screen creating unit 116 generates screen data for displaying the enemy character whose parameter has been changed (S104). In the above-described case, screen data where a gauge indicating the HP of the enemy character has decreased is generated (see FIG. 5A). In addition, screen data including a special effect indicating that the enemy character is in a capturable state may be generated. For example, the HP gauge of the enemy character may be allowed to blink, or text information such as “capture chance!” may be displayed on the screen (see FIG. 5B).

The screen data generated by the server device 10 is transmitted to the player terminal 20 and displayed on the terminal display unit 24 (S105). After the player verifies the displayed screen, the player presses a capture button 54 (see FIG. 5B) to request to capture the enemy character (S106). Note that the processes at S105 and S106 may be omitted and the process may be performed assuming that at the stage where the request to use a capture assisting item is made (S101), a request to capture the enemy character is made at the same time.

When the acceptance processing unit 111 of the server device 10 accepts the request to capture the enemy character (S107), the success rate determining unit 114 determines the capture success rate of the enemy character, according to the parameter of the enemy character changed at S103 (S108). The capture success rate may be determined based on a set table or may be determined based on an equation for calculating the capture success rate.

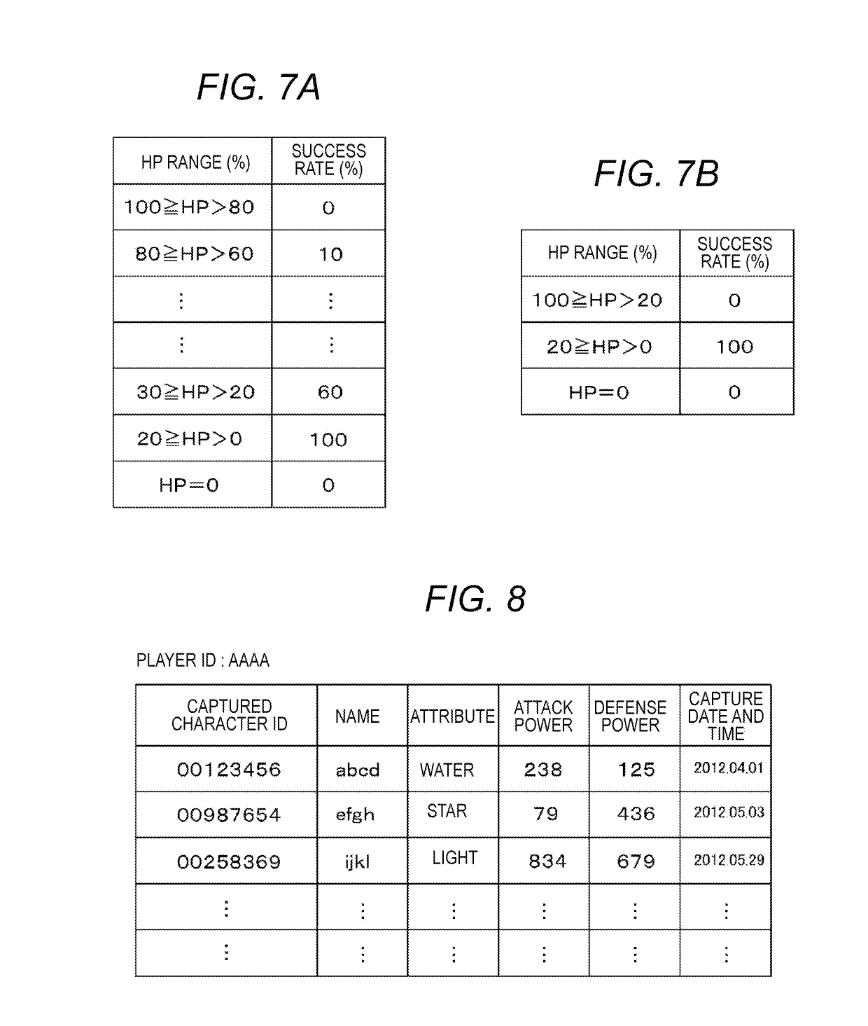

FIGS. 7A and 7B show examples of a table for determining the capture success rate. In a table in FIG. 7A, the capture success rate is 0% when the HP of an enemy character to be captured is in the range from greater than 80% of the maximum value of the HP to less than or equal to 100%, and the capture success rate is 10% in the range from greater than 60% of the maximum value of the HP to less than or equal to 80%. The capture success rate is 100% in the range from greater than 0% of the maximum value of the HP to less than or equal to 20%. That is, the capture success rate is set such that the lower the HP of the enemy character the higher the capture success rate. Note, however, that when the HP is 0%, the capture success rate is 0%. The capture success rate may be set more minutely according to the HP of the enemy character or may change within a predetermined range. On the other hand, in a table in FIG. 7B, for an enemy character to be captured, the capture success rate is 0% in the range greater than 20% of the maximum value of the HP, and the capture success rate is 100% in the range from greater than 0% of the maximum value of the HP to less than or equal to 20%. That is, in the case of FIG. 7B, a determination as to whether capture has succeeded is made using a magnitude of 20% of the maximum value of the HP as a threshold value. Such tables may be set for each type of enemy character or may be used for all enemy characters in a shared manner.

The success rate determining unit 114 can also change the capture success rate according to whether the capture assisting item is used. Specifically, a higher capture success rate is set when the HP of the enemy character is reduced by using the capture assisting item than when the HP of the enemy character is reduced by performing a normal attack. For example, in the case in which the capture success rate, when the HP of the enemy character is reduced to 30% by a normal attack, is 60%, the capture success rate, when the HP of the enemy character is reduced to 30% by using the capture assisting item, is set to 90% which is +30% higher. By this, an effect obtained when the capture assisting item is used is brought about more remarkably. Alternatively, the setting may be performed such that the enemy character can be captured with a probability of 100% by using the capture assisting item. By setting a higher capture success rate when the capture assisting item is used, the player is likely to be motivated to use the capture assisting item.

Subsequently, the capture determining unit 113 determines whether the capture has succeeded (S109). The determination as to whether the capture has succeeded is made based on the capture success rate which is determined according to the parameter of the enemy character at S108. As described above, the parameter of the enemy character changes to a sufficiently low level when the capture assisting item is used (S103), and the capture success rate is determined to be high accordingly (S108). Therefore, in the present embodiment, it is less likely that the capture is determined to “fail” in spite of the use of the capture assisting item. Note, however, that to enhance the game's fun factor, the setting may be performed such that capture fails at a certain rate. For example, a process may be performed in which the chance of success in capture is changed by increasing or decreasing the capture success rate by multiplying the capture success rate by a coefficient which is generated using a random number, etc.

If it is determined that the capture has succeeded, capture information indicating that the enemy character has been captured by the player is stored in the data storage unit 12 (S110). The capture information is managed using the IDs of the player and the enemy character. FIG. 8 shows an example of data managed as capture information. Note that if it is determined that the capture has failed, capture information is not stored in the data storage unit 12.

When the capture has succeeded, the capture processing unit 115 allows the data storage unit 12 to store the ID registered for the captured enemy character in association with the player ID. Specifically, information such as ID, name, attribute, attack power, defense power, and capture date and time is recorded for each enemy character in a player's capture list. In the list, information is added every time the player captures a new enemy character. The player can trade an enemy character managed in the capture list for an enemy character captured by another player, or can call a desired character in the list upon a battle to allow the character to participate in the battle.

In addition, the screen creating unit 116 generates data on a capture result screen showing the result of the capture (S111). When it is determined that the capture has succeeded, the screen creating unit 116 generates data on a capture success screen such as that shown in FIG. 4C.

The generated data on a capture result screen is transmitted to the player terminal 20, and the capture result screen is displayed on the terminal display unit 24 (S112). The player can verify whether the capture of the enemy character has succeeded, by looking at the capture result screen.

As such, by using the capture assisting item, it becomes easier to capture an enemy character to be captured, and thus, the player's convenience increases.

<Variant>

The control unit 11 of the server device 10 may be configured to not include the success rate determining unit 114. For example, the capture determining unit 113 can be configured to be able to determine whether capture has succeeded, only by the magnitude of a parameter (HP, etc.) of an enemy character. In this case, the capture determining unit 113 determines that capture has succeeded when the parameter of the enemy character changed by the parameter change processing unit 112 is smaller than a predetermined value. Otherwise, the capture determining unit 113 determines that capture has failed. That is, a determination as to whether capture has succeeded is made by whether the changed parameter of the enemy character is greater or smaller than a predetermined threshold value. By doing so, the processing load on the control unit 11 upon capturing is reduced. In addition, the configuration of the device itself is simplified, enabling to keep costs low.

### Other Embodiments

The above-described embodiment is provided to facilitate understanding of the present invention and is not to be construed as limiting the present invention. The present invention may be changed or modified without departing from the spirit and scope thereof, and needless to say, the present invention includes equivalency thereof. In addition, embodiments described below are also included in the present invention.

<For The Parameters Of An Enemy Character>

Although in the above-described embodiment a process is described in which a determination as to whether capture has succeeded is made with reference to mainly hit points (HP) which is one of the parameters of an enemy character, the configuration is not limited thereto. For example, the configuration may be such that a different parameter (capture points) than the HP for making a determination as to whether capture has succeeded is provided separately, and a determination as to whether capture has succeeded is made according to a change in the capture points. Alternatively, the configuration may be such that the attack power, defense power, or the like, of an enemy character is changed due to the use of a capture assisting item, and a determination as to whether capture has succeeded is made according to the changed attack power or defense power.

<For The Application Range Of A Capture Assisting Item>

In the above-described embodiment, a capture assisting item can be used regardless of the type or condition of an enemy character, but restrictions may be placed on a capture assisting item availability condition.

For example, there are a plurality of types of capture assisting items, and available items are limited according to the magnitude of the HP of an enemy character. Specifically, when there is a “capture assisting item available in the HP range of 10000 or less”, the capture assisting item is available to those enemy characters whose HPs are 10000 or less, but is not available to those enemy characters whose HPs are greater than 10000. In this case, the player needs to attack an enemy character to reduce its HP to 10000 or less and then use the capture assisting item, or needs to select a capture assisting item applicable in other ranges (e.g., a capture assisting item available in the HP range from 100000 to 10000). By performing setting such that, for example, the higher the application range of a capture assisting item the more difficult it is to acquire the capture assisting item, the game's fun factor can be enhanced.

Alternatively, available capture assisting items may be limited according to the attribute of an enemy character. For example, in FIG. 8, there are enemy characters whose attributes are “water”, “star”, and “light”, and the same attributes are also set for capture assisting items, and restrictions can be placed such that, for example, for an enemy character having a certain attribute, a capture assisting item having the same attribute needs to be used.

<For The Timing Of Use Of A Capture Assisting Item>

Although in the above-described example, the player can use a capture assisting item at any timing during a battle, restrictions may be placed on capture assisting item available timing. For example, a capture assisting item may be made available only during Fever Time which occurs by some kind of trigger, e.g., when an enemy character is weak (when the HP is reduced to a certain extent) or when an enemy character is off guard. Note that in the case of adding such usage restrictions, in order to prevent the player from losing the zest for a game, it is desirable to perform setting such that capture succeeds with a probability of 100% with the use of a capture assisting item.

<Use Of A Capture Assisting Item In A Raid Boss Battle>

In a battle during a game, an event may occur in which a plurality of players cooperate and challenge against a stronger boss character than normal enemy characters. A capture assisting item may be made available when doing battle with such boss character (which is also called a raid boss). For example, the configuration may be such that in order to facilitate capturing of a raid boss by player B, a friend, player A uses a capture assisting item for player B to reduce a parameter (HP) of the raid boss.

<Information Processing Device>

Although in the above-described embodiment description is made using, as an example, the game system 1 including one server device 10 as an example of an information processing device, the configuration is not limited thereto and a game system 1 may include a plurality of server devices 10 as information processing devices. Specifically, a plurality of server devices 10 may be connected through a network 2, and the server devices 10 may perform various types of processes in a distributed manner.

Alternatively, the configuration may be such that a player terminal 20 has part of the function of an information processing device. In this case, the server device 10 and the player terminal 20 configure an information processing device.

<Game Program>

In the game system 1 in the above-described embodiment, description is made of the case, as an example, in which various types of processes for capturing an enemy character in a battle are performed by allowing the server device 10 and a player terminal 20 to operate in cooperation with each other. The present invention also includes a game program for performing those processes. Specifically, the server device 10 serving as an information processing device and a player terminal 20 may perform the above-described processes based on the game program.

What is claimed is:

1. A server device connected to a player terminal through a network and controlling a game in which when a player does battle with an enemy character, the player can capture the enemy character, the server device comprising:
a storage unit that stores information about a parameter of the enemy character and about the enemy character captured by the player during the game;
an acceptance processing unit that accepts requests from the player through the player terminal to use a predetermined item and to capture the enemy character;
a parameter change processing unit that changes the parameter of the enemy character stored in the storage unit, when the request to use the predetermined item is accepted;
a capture determining unit that determines, when the request to capture the enemy character is accepted, whether capture of the enemy character has succeeded, according to the parameter of the enemy character changed by the parameter change processing unit; and
a capture processing unit that allows the storage unit to store information when it is determined that the capture of the enemy character has succeeded, the information indicating that the enemy character has been captured by the player.

2. The server device according to claim 1, wherein when the request to use the predetermined item is accepted by the player, the parameter change processing unit reduces the parameter of the enemy character such that the parameter does not fall below a set lower limit.

3. The server device according to claim 1, wherein
the storage unit stores a parameter of a character of the player, and
when the request to use the predetermined item is accepted by the player, the parameter change processing unit does not change the parameter of the character of the player stored in the storage unit.

4. The server device according to claim 1, comprising a capture success rate determining unit that determines a capture success rate used upon capturing the enemy character, according to the parameter of the enemy character changed by the parameter change processing unit, wherein
the capture success rate determining unit sets a higher capture success rate of the enemy character when the predetermined item is used than when the predetermined item is not used.

5. A non-transitory computer-readable storage medium storing a game program that causes an information processing device to perform a game in which when a player does battle with an enemy character, the player can capture the enemy character, and that causes the information processing device to perform:
a process of storing, in a storage unit, information about a parameter of the enemy character and about the enemy character captured by the player during the game;
a process of accepting requests from the player to use a predetermined item and to capture the enemy character;
a process of changing the parameter of the enemy character stored in the storage unit, when the request to use the predetermined item is accepted;
a process of determining, when the request to use the predetermined item is accepted, whether capture of the enemy character has succeeded, according to the parameter of the enemy character changed by a parameter change processing unit; and
a process of allowing the storage unit to store information when it is determined that the capture of the enemy character has succeeded, the information indicating that the enemy character has been captured by the player.
